(19) United States
(12) Patent Application Publication
(10) Pub. No.: US 2025/0258100 A1
(43) Pub. Date: Aug. 14, 2025

(54) BIO-AEROSOL DETECTION APPARATUS

(71) Applicants: Applied Research Associates, Inc., Albuquerque, NM (US); US ARMY DEVCOM CHEMICAL BIOLOGICAL CENTER, Aberdeen Proving Ground, MD (US)

(72) Inventors: Brian Joseph Zadler, Golden, CO (US); Richard Alan Cayer, Littleton, CO (US); Gian Lucca Cervo, Centennial, CO (US); Bruno Christian Mary, Aurora, CO (US); Jennifer Nicole Jerding, Wheat Ridge, CO (US); Aime Poldmae Goad, Fallston, MD (US); Gary Kenneth Kilper, Perry Hall, MD (US)

(21) Appl. No.: 18/632,862

(22) Filed: Apr. 11, 2024

Related U.S. Application Data
(60) Provisional application No. 63/495,714, filed on Apr. 12, 2023.

(51) Int. Cl. G01N 21/64

(52) U.S. Cl. CPC G01N 21/6486; G01N 21/645; G01N 2021/6482; G01N 2201/0221; G01N 2201/126

(57) ABSTRACT

A system for bio-aerosol detection includes a user interface disposed on an outer housing, the user interface comprising a multi-select switch, a display screen, a status LED, and an alert LED. The system for bio-aerosol detection further includes a bio-aerosol detection unit comprising: an open cavity configured to receive air from the inlet and exhaust air to the outlet, a bio-fluorescing light configured to illuminate the open cavity, a single bio-fluorescence detection sensor configured to observe the open cavity, a light reducing beam dump configured to receive excess light from the bio-fluorescing light.

### RELATED APPLICATIONS

This application claims priority to earlier-filed U.S. Provisional Patent Application No. 63/495,714, entitled “BIO-AEROSOL DETECTION APPARATUS”, which is hereby incorporated by reference in its entirety into the present application.

### STATEMENT OF GOVERNMENTAL SUPPORT

This invention was made with government support under N4175619C3045 awarded by the United States Irregular Warfare Technical Support Directorate. The government has certain rights in the invention.

### BACKGROUND

### 1. Field

Embodiments of the present invention relate to bio-aerosol detection, and more particularly to wearable devices for bio-aerosol detection.

### 2. Related Art

Traditionally, bio-aerosol detection apparatuses are carried due to their size and shape which prevents them from being worn. For example, current bio-aerosol detection apparatuses use multiple photomultiplier tubes for bio-aerosol detection which adds significant weight and size to the apparatus. Further, current bio-aerosol detection apparatuses use external air intakes that increase the overall size of the bio-aerosol detection apparatus negatively impacting wearability. Some current bio-aerosol detection apparatuses exceed 400 in³, rendering wearability impractical and reducing transportability. Finally, current bio-aerosol detection apparatuses consume a significant amount of power, which increases the weight and size of the bio-aerosol detection apparatus by requiring more or larger batteries compared to a system that consumes less power.

### SUMMARY

Embodiments of the present invention are directed to addressing the above-discussed need by providing novel systems for a wearable bio-aerosol detection apparatus. The wearable bio-aerosol detection apparatus may be constructed with an outer housing such that the interior of the device is protected against water ingress. The apparatus may have a user interface located on the exterior of the device configured to provide visual feedback for the user. The user interface may also be configured to receive input from the user to provide information to the system. Further, the apparatus may have an inlet and outlet to receive air into the device and exhaust air out of the device respectively. The apparatus may also comprise a bio-aerosol detection unit comprising an open cavity configured to receive air from the inlet and exhaust air to the outlet, a bio-fluorescing light, a single bio-fluorescence detector, and a light reducing beam dump. The bio-aerosol detection unit may be connected to a processor and non-transitory memory containing computer program code that, when executed by a processor, causes the processor to receive bio-detection information from the bio-detection apparatus, analyze the bio-detection information, and determine a biological threat level based upon the analysis of the bio-detection information. In particular, in a first exemplary embodiment, the apparatus displays the threat level to the user via an included display screen and an included warning LED. The display screen and warning LED are configured to display information in both the infrared and visible light spectrum. The computer processor records any bio-detection information and stores the bio-detection information on removable computer-readable non-transitory memory.

In a second exemplary embodiment, the wearable bio-aerosol detection apparatus comprises an outer housing, an interior inlet disposed within the outer housing, an exterior outlet configured to exhaust air from within the wearable bio-aerosol detection apparatus, an air pump configured to draw air through the inlet, a user interface comprising; a multi-select switch, a keypad for inputting information, and a display screen, a bio-aerosol detection unit disposed within the outer housing comprising; an open cavity configured to receive air from the inlet and release air to the exterior outlet, a bio fluorescing light configured to illuminate the open cavity, a single bio-fluorescence detection sensor configured to observe the open cavity, a light reducing beam dump configured to receive excess light from the bio-fluorescing light illuminating the open cavity, and a computer processor and supporting electronics configured to receive data from the bio-aerosol detection unit and further configured to calculate a number of bio-aerosol particles present in the open cavity and further configured to alert a user via a warning light when the number of bio-aerosol particles crosses a certain threshold.

In a third exemplary embodiment, the wearable bio-aerosol detection apparatus comprises an outer housing, a user interface comprising at least two of, a multi-select switch, a user interface screen, and a status LED, an interior inlet comprising; a closed volume cavity within the outer housing and an inlet port through the outer housing, a bio-aerosol detection unit comprising; a bio-fluorescing light, a single bio-fluorescence detector, and a light reducing beam dump, an exterior outlet comprising; an outlet port and an outlet port seal, a filter for collecting samples of bio-aerosols detected by the bio-aerosol detection unit, and at least one non-transitory memory containing computer program code that, when executed by a processor, causes the processor to receive bio-aerosol detection information from the bio-aerosol detection unit, analyze the bio-aerosol detection information, compute a threat status based upon the bio-aerosol detection information, and display the threat status via the user interface.

In another embodiment the bio-aerosol detection apparatus further comprises a wireless receiver and transmitter connected to a computer processor and non-transitory memory such that the device may transmit bio-detection information collected by the bio-detection unit to a second wirelessly connected device. In some embodiments, the second wirelessly connected device may comprise a smartphone, a head-mounted display (HMD), a wearable computer watch, or a laptop computer.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE FIGURES

Embodiments of the invention are described in detail below with reference to the attached drawing figures, wherein:

FIG. 1 depicts an exemplary embodiment of the exterior user interface for the bio-aerosol detection apparatus;

FIG. 2 shows an exemplary embodiment of the bio-aerosol detection apparatus;

FIG. 3A depicts an exemplary embodiment of the top and bottom faces of the bio-aerosol detection apparatus;

FIG. 3B depicts and exemplary embodiment of the inlet port and inlet cap of the bio-aerosol detection apparatus;

FIG. 3C depicts an exemplary embodiment of the back and side view of the bio-aerosol detection apparatus;

FIG. 4A depicts an exemplary embodiment of the MOLLE bracket and MOLLE bracket attachment point of the bio-aerosol detection apparatus;

FIG. 4B depicts an exemplary embodiment of the MOLLE bracket attachment point and a method of attaching the MOLLE bracket to the bio-aerosol detection apparatus;

FIG. 5 depicts an exemplary embodiment of the removable memory slot and cover;

FIG. 6 depicts an exemplary embodiment of the interior arrangement of components of the bio-aerosol detection apparatus;

FIG. 7 depicts an exemplary embodiment of the interior inlet of the bio-aerosol detection apparatus;

FIG. 8 depicts an exemplary method of operation for the bio-aerosol detection apparatus; and

FIG. 9 depicts an exemplary embodiment of the layout of the graphical user interface displayed by the bio-aerosol detection apparatus.

The drawings do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention relate to a wearable bio-aerosol detection apparatus for detecting the presence of biological threats configured to inlet air and analyze the number of bio-particles present in the air around the wearable bio-aerosol detection apparatus. The wearable bio-aerosol detection apparatus is configured to be small and portable to allow for the user to wearably attach the device to articles of clothing such as belts, vests, backpacks, bandoliers, or any other article of clothing. This provides a significant improvement over the previous art in this sector by providing a small, wearable replacement for large, unwearable bio-aerosol detection apparatuses.

Embodiments of the present disclosure provide a bio-aerosol detection apparatus that is wearably sized and weighted. Specifically, a bio-aerosol detection apparatus that reduces the size, weight, and shape compared to the current state of the art such that the bio-aerosol detection apparatus is wearably sized and weighted. Smaller and lighter batteries may be provided such that the size and weight of the bio-aerosol detection apparatus is reduced in conjunction with the use of internal air inlets and outlets such that the bio-aerosol detection apparatus does not possess protruding intakes and outlets that reduce wearability of the bio-aerosol detection apparatus. A reduction in power consumption through more modern electronics and devices may be provided to reduce reliance on large or heavy batteries such that the weight and size of the bio-aerosol detection apparatus is reduced.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

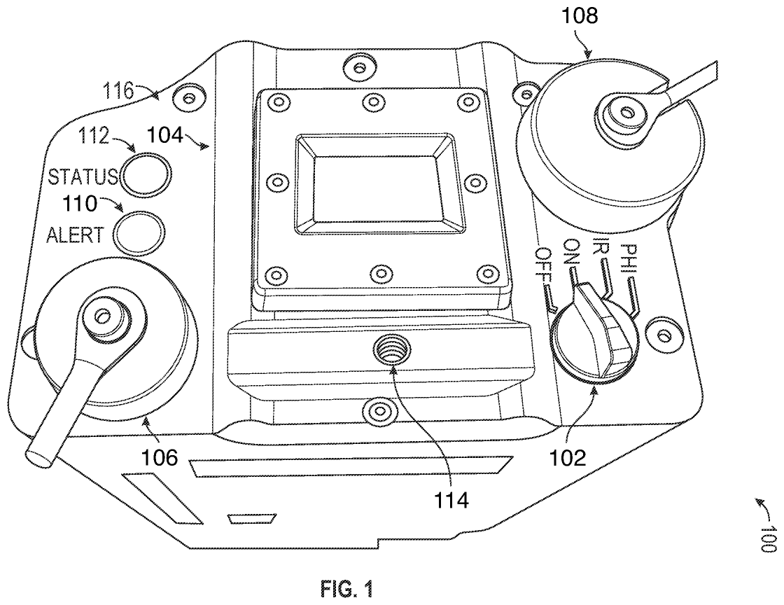

Turning first to FIG. 1, bio-aerosol detection apparatus 100 is illustrated in an exemplary embodiment. In some embodiments, Bio-aerosol detection apparatus 100 may comprise a user-interface further comprising a plurality of individual components. Bio-aerosol detection apparatus 100 is oriented such that a plurality of individual components comprising a user interface are oriented in view and some elements of bio-aerosol detection apparatus 100 such as the MOLLE bracket alignment tabs and MOLLE bracket are not shown. In this exemplary embodiment, the user interface comprises a status LED 112, an alert LED 110, a display screen 104, a filter cap 108, a battery cap 106, a MOLLE bracket attachment point 114, and a multi-select switch 102.

Multi-select switch 102 may comprise a toggle switch, a rotary selector switch, a dial, a lever switch, or any other multi-modal switch, mechanical or digital. In some embodiments, status LED 112 and alert LED 110 may be configured to illuminate in both the visible light spectrum and the infrared light spectrum.

In some embodiments, display screen 104 may be configured to illuminate in the visible light spectrum and the infrared light spectrum. In some such embodiments, display screen 104, status LED 112, and/or alert LED 110 may be configured to begin illuminating in the infrared light spectrum when multi-select switch 102 is switched to an infrared (IR) mode. Further, multi-select switch 102 may comprise a silent mode (PHI) such that bio-aerosol detection apparatus 100 produces no audible alarms or sounds. In some embodiments, bio-aerosol detection apparatus 100 illuminates display screen 104, status LED 112, and alert LED 110 when multi-select switch 102 is switched to a silent mode (PHI). In some embodiments, the mode select switch is configured to have modes such as off, on, silent, and infrared. In some embodiments, multi-select switch 102 comprises two separate switches, respectively controlling power and feedback mode. In some embodiments, multi-select switch 102 is integrated into the computer program code of the device and is accessed through a touch-screen function of display screen 104 to provide digital switches for changing the mode of the device.

Display screen 104 may comprise any screen of wearable size configured to display bio-aerosol detection information. In some embodiments, display screen 104 is disposed on the same side of the device as the user interface. In some embodiments, display screen 104 comprises a liquid crystal display, a plasma screen, an e-ink display, an organic light emitting diode display, a cathode ray tube display, or any other display screen, now known or later developed. In some embodiments, multi-select switch 102 may be further configured to power on and power off the device. The arrangement of these components in FIG. 1 is exemplary and it is noted that any of these components may be disposed to another face of bio-aerosol detection apparatus 100 or placed at any other suitable position on the device without departing from the scope of the present invention.

In some embodiments, bio-aerosol detection apparatus 100 further comprises a vibration motor configured to provide physical feedback to the user. The vibration motor may be disposed within outer housing 116. Further, the vibration motor may be configured to provide haptic feedback when multi-select switch 102 is switched to a silent mode. Furthermore, when multi-select switch 102 is configured in a silent position the auditory alarm may be silenced and all feedback provided to the user may be visual. The vibration motor may be configured to provide physical feedback to the user when multi-select switch 102 is configured in an ON position. Further, the vibration motor may be configured to provide physical feedback when a high bio-aerosol threat level is detected.

Bio-aerosol detection apparatus 100 may be configured to be wearably sized such that bio-aerosol detection apparatus 100 may be worn on clothing, accessories, or gear worn by a user without significantly hindering the mobility of the user. Bio-aerosol detection apparatus 100 may have external dimensions of approximately 4.75 inches×2.5 inches×5.75 inches, having a total volume of less than 80 in³ such that bio-aerosol detection apparatus 100 is wearably sized. Furthermore, bio-aerosol detection apparatus 100 may weigh 2.25 pounds or less, such that bio-aerosol detection apparatus 100 is wearably weighted.

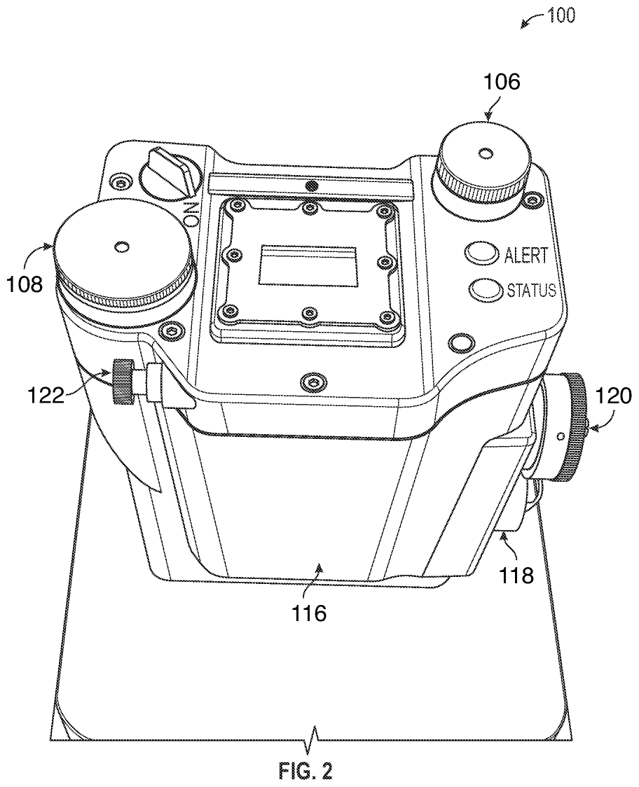

Turning now to FIG. 2, bio-aerosol detection apparatus 100 is illustrated to emphasize the external components providing a water-tight seal for the internal components. In some embodiments, bio-aerosol detection apparatus 100 comprises outer housing 116. Broadly, outer housing 116 is a casing containing and protecting the internal components of bio-aerosol detection apparatus 100. Further, outer housing 116 comprises an inlet port 118 and an outlet port 122 such that the system may intake air through inlet port 118 and exhaust air through outlet port 122. The inlet and outlet ports may be arranged at any point across the surface of outer housing 116. Outer housing 116, inlet port 118, outlet port 122, and any other exterior element of bio-aerosol detection apparatus 100 may be sufficiently sealed to provide protection against water ingress or to provide waterproofing.

In use, bio-aerosol detection apparatus 100 may determine a background bio-aerosol particle count and current bio-aerosol particle count. Bio-aerosol detection apparatus 100 achieves this by drawing air through inlet port 118 and into the bio-aerosol detection unit (not shown) enclosed by outer housing 116. When not in use, inlet port 118 is configured to be sealed with inlet cap 120, as discussed below. The bio-aerosol detection unit analyzes the air drawn through inlet port 118 and then exhausts the analyzed air through outlet port 122. In some embodiments, outlet port 122 further comprises an outlet port seal. In some embodiments, outlet port 122 comprises a thumb screw and a gasket configured to seal outlet port 122 from water ingress. In some such embodiments, the gasket may be disposed around the base of the thumb screw such that the gasket seals the outlet port 122 from water ingress when the thumb screw is tightened.

In some embodiments, bio-aerosol detection apparatus 100 comprises battery cap 106 and filter cap 108. Battery cap 106 covers a battery storage tube configured to provide power to bio-aerosol detection apparatus 100. Battery cap 106 may be configured to be attached to the rest of bio-aerosol detection apparatus 100 with a cable such that when battery cap 106 is removed from the device, battery cap 106 is still sufficiently attached such that loss of battery cap 106 is prevented when changing batteries. In some embodiments, battery cap 106 is not present. In such an embodiment, bio-aerosol detection apparatus 100 may further comprise rechargeable batteries disposed within outer housing 116. In some embodiments, a charging port is disposed through outer housing 116 such that the rechargeable batteries may be recharged. In some embodiments, battery cap 106 and filter cap 108 are incorporated together to provide a battery and filter cap that provides access to both batteries and a filter. In some embodiments, filter cap 108 is configured to provide access to an internal filter such that the internal filter may be replaced by removing filter cap 108.

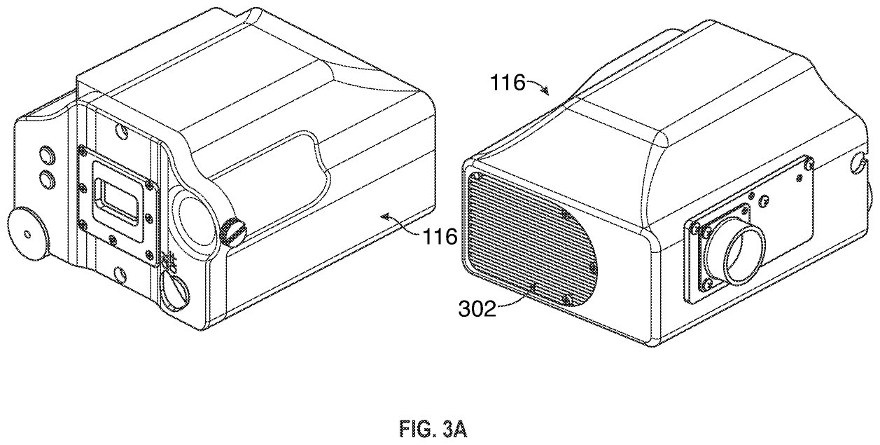

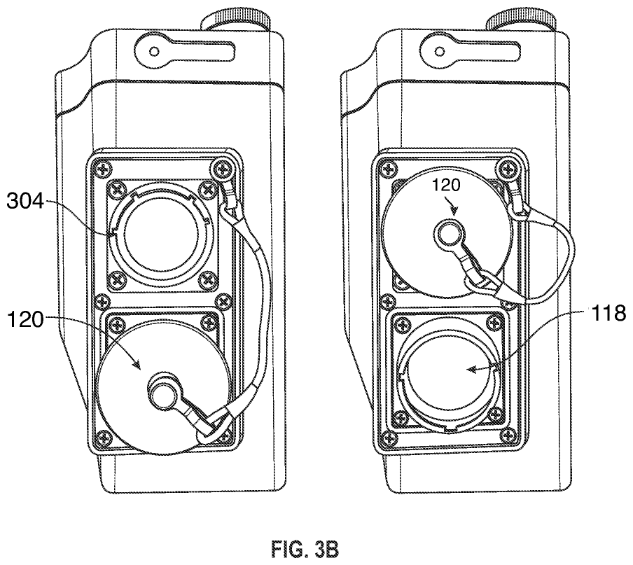

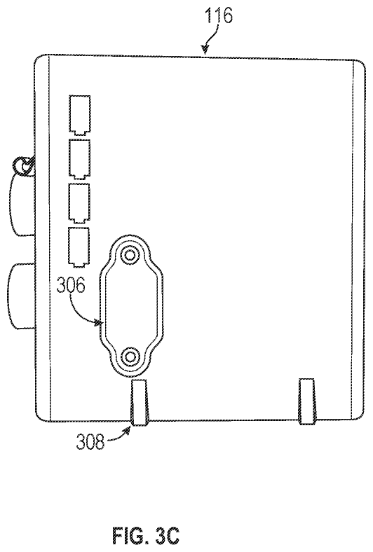

Turning now to FIG. 3A, a perspective view of bio-aerosol detection apparatus 100 is shown. As shown, bio-aerosol detection apparatus 100 may further comprise speaker outlet 302. Speaker outlet 302 covers a speaker configured to audibly sound warnings of threats detected by the bio-aerosol detection unit disposed within outer housing 116. In some embodiments, speaker outlet 302 covers an internal buzzer configured to audibly sound alerts to the user. In some embodiments, the speaker covered by speaker outlet 302 also comprises an internal buzzer configured to provide auditory and physical feedback to the user.

In some embodiments, outer housing 116 may be configured to be sufficiently resistant to impacts and transport such that bio-aerosol detection apparatus 100 may be significantly protected from damage from impacts, scraping, shaking, slashing, and other physically harmful phenomena that may damage a worn device. Furthermore, outer housing 116 may be further configured to be resistant to small arms fire such that the internal components are sufficiently protected from bullet impacts and such that bio-aerosol detection apparatus 100 may continue to function after receiving bullet impacts from small arms fire.

Turning now to FIG. 3B, a side view of bio-aerosol detection apparatus 100 is depicted, illustrating the sealing function of inlet cap 120. As described above, inlet port 118 is configured to be sealed with inlet cap 120. Inlet cap 120 may be stored on inlet cap mount 304 when not sealing inlet port 118. Furthermore, inlet cap 120 is configured to be connected to bio-aerosol detection apparatus 100 by a cable, as depicted. This cable prevents the loss of inlet cap 120 when moving inlet cap 120 from inlet port 118 to inlet cap mount 304 or vice versa. The user, when operating bio-aerosol detection apparatus 100, may unseal the inlet port 118 by removing inlet cap 120. The user may let inlet cap 120 hang from the device by its cable or the user may fasten inlet cap 120 to inlet cap mount 304. Inlet cap mount 304 and inlet port 118 may be disposed in any formation that allows inlet cap 120 to be moved between them without departing from the scope of this invention.

Turning now to FIG. 3C a back view of bio-aerosol detection apparatus 100 is depicted. Bio-aerosol detection apparatus 100 may comprise computer-readable memory storage slot 306. Computer-readable memory storage slot 306 may contain any of a USB flash memory drive, a micro-hard disk drive, a solid-state drive, a magnetic tape cassette, a compact disc, or a digital versatile disk. Additionally, computer-readable memory storage slot 306 may be sufficiently sized to fit any compact memory medium, now known or later developed. Further, bio-aerosol detection apparatus 100 may not include computer-readable memory storage slot 306 and instead include a wireless receiver and transmitter configured to transmit bio-aerosol detection data to a secondary device comprising a wireless receiver and transmitter connected to a computer processor and supporting electronics such that the bio-aerosol detection information may be processed by the secondary device comprising a wireless receiver and transmitter connected to a computer processor and supporting electronics.

Bio-aerosol detection apparatus 100 may further comprise MOLLE bracket alignment tabs 308. The MOLLE bracket alignment tab 308 may be configured to align a MOLLE bracket that is mounted to bio-aerosol detection apparatus 100. MOLLE bracket alignment tab 308 may be configured to interface with a MOLLE bracket such that bio-aerosol detection apparatus 100 is wearable by a user and is configured to be wearably sized and selectively removable.

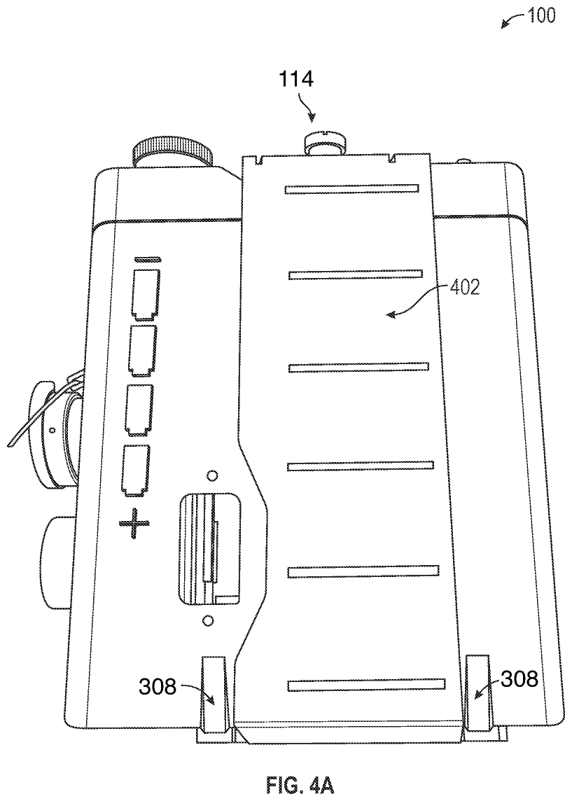

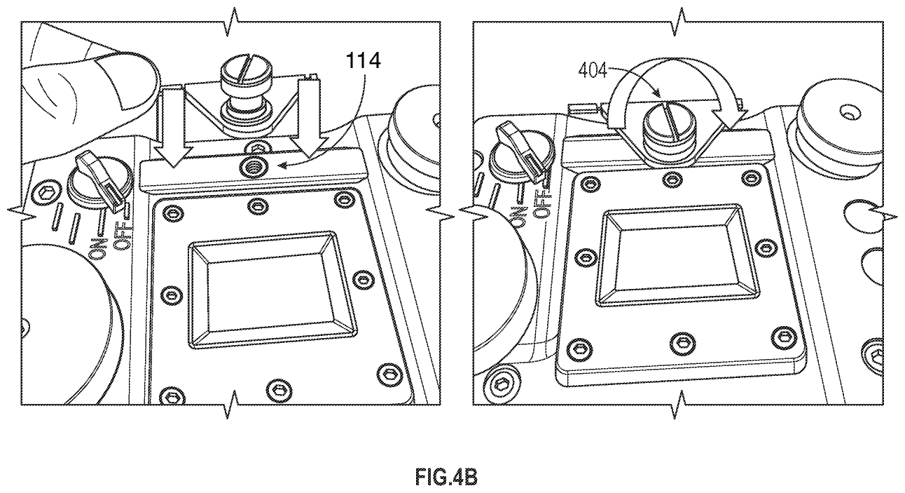

Turning now to FIG. 4A, a view of bio-aerosol detection apparatus 100 with the MOLLE bracket attached is shown. Broadly, MOLLE bracket 402 is configured to interface with the MOLLE system present on vests, backpacks, and other wearable items compliant with the MOLLE system. MOLLE bracket 402 comprises a bar configured to attach to bio-aerosol detection apparatus 100 and a series of MOLLE system weaving slots configured to accept a MOLLE strap thereby attaching MOLLE bracket 402 to the MOLLE system. Bio-aerosol detection apparatus 100 may further comprise MOLLE bracket alignment tabs 308. MOLLE bracket alignment tabs 308 may be configured to align MOLLE bracket 402 directly with mounting hardware attached to the device. MOLLE bracket 402 may be attached to bio-aerosol detection apparatus 100 via MOLLE bracket attachment point 114. Bio-aerosol detection apparatus may further comprise MOLLE bracket attachment holes configured to accept MOLLE bracket attachment pegs attached to MOLLE bracket 402. In some embodiments, MOLLE bracket 402 has a plurality of MOLLE bracket attachment pegs and bio-aerosol detection apparatus 100 further comprises a plurality of MOLLE bracket attachment holes. In some embodiments, bio-aerosol detection apparatus 100 may be configured to attach to MOLLE bracket 402 with mechanical clips, or any other rigid fastening system, now known or later developed.

Turning now to FIG. 4B, an illustration of the attachment of MOLLE bracket 402 using MOLLE bracket attachment point 114 is depicted. In some embodiments, MOLLE bracket attachment point 114 comprises a thumb screw 404 and corresponding screw hole. In some embodiments, bio-aerosol detection apparatus 100 is additionally mounted to the MOLLE bracket using mounting pegs and holes. The mounting pegs and holes may be disposed to the bottom of outer housing 116 such that the pegs and holes form an at least 3-point mounting system to provide stable mounting for the bracket. In some embodiments, MOLLE bracket 402 is attached to MOLLE bracket attachment point 114 by first attaching the MOLLE bracket mounting pegs to the MOLLE bracket mounting holes, then by fastening MOLLE bracket 402 to MOLLE bracket attachment point 114 using thumb screw 404.

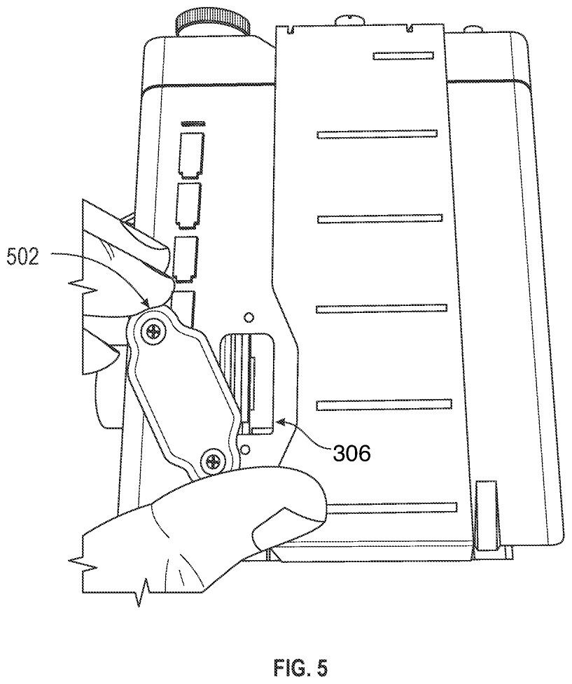

Turning now to FIG. 5 an exemplary embodiment of bio-aerosol detection apparatus 100 is displayed. In some embodiments, Bio-aerosol detection apparatus 100 may include computer-readable memory storage slot cover 502. In some embodiments, computer-readable memory storage slot cover 502 is configured to cover computer-readable memory storage slot 306. In some embodiments, computer-readable memory storage slot cover 502 is configured to seal computer-readable memory storage slot 306 from water ingress. In some embodiments, computer-readable memory storage slot cover 502 is fixed to outer housing 116 via screws. In some embodiments, computer-readable memory storage slot cover 502 is configured to attach to computer-readable memory storage slot 306 and outer housing 116 via mechanical clips. In some embodiments, computer-readable memory storage slot cover 502 is glued to outer housing 116.

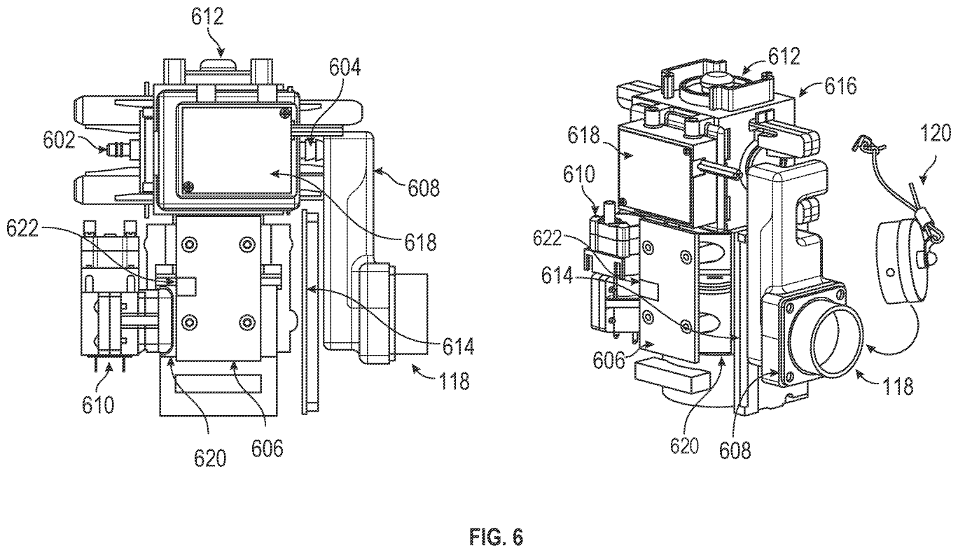

Turning now to FIG. 6, an exemplary arrangement of certain interior components disposed within outer housing 116 is displayed. Each of the components along with any other additional components may be arranged in any feasible way such that their functionality is not lost without departing from the scope of the present invention. In some embodiments, the interior arrangement comprises open cavity outlet 602 and open cavity inlet 604. Open cavity inlet 604 is configured to be connected to interior inlet 608 such that the air drawn through interior inlet 608 is directed through open cavity inlet 604. Interior inlet 608 may be disposed through outer housing 116. Interior inlet 608 is connected to inlet port 118, allowing inlet cap 120 to provide water ingress protection for inlet port 118. The interior arrangement may further include electronics boards 606 and 614. Electronics board 606 and 614 may comprise a computer processor, non-transitory read-only memory containing computer program code, random access memory modules, graphics processing units, microcontrollers, field programmable gate arrays (FPGA), supporting circuitry for sensors, processors, and any other supporting electronics, now known or later developed. In some embodiments, electronics boards 606 and 614 may be integrated into a single electronics board. In some embodiments, electronics boards 606 and 614 and all electronics present on them are integrated into a system on a chip (SOC).

In some embodiments, electronics boards 606 and 614 may be configured to receive bio-aerosol detection information from bio-fluorescence detection sensor 618. In some embodiments, bio-fluorescence detection sensor 618 comprises a single bio-fluorescence detection sensor such that bio-aerosol detection apparatus 100 is wearably sized. In some embodiments, electronics boards 606 and 614 are communicatively connected to bio-fluorescence detection sensor 618 such that bio-aerosol detection information is transmitted from bio-fluorescence detection sensor 618 to electronics boards 606 and 614 and further transmitted to a computer processor and supporting electronics present on electronics boards 606 and 614. Bio-fluorescence detection sensor 618 may comprise a photomultiplier tube (PMT), a micro PMT or any other such light amplifying sensor configured to detect bio-fluorescence. The photomultiplier tube may be configured to amplify light above a predetermined threshold and provide bio-fluorescence detection information to the computer processor for analysis and calculation regarding the threat level of bio-aerosols present in the air.

In some embodiments, bio-aerosol detection apparatus may comprise a bio-aerosol detection unit comprising open cavity 616, open cavity outlet 602, open cavity inlet 604, bio-fluorescence detection sensor 618, light reducing beam dump 612, and bio-fluorescing light 620. As described above, air from the environment flows from interior inlet 608 through open cavity inlet 604, passes through open cavity 616 and is exhausted out of open cavity outlet 602. In some embodiments, open cavity 616 further comprises computer-controlled hatches that seal open cavity 616 unless disengaged by the computer. In some embodiments, open cavity 616 is configured to allow airflow directly from the exterior of the device. The interior arrangement may further comprise air pump 610. Air pump 610 is configured to pump air through interior inlet 608, into open cavity inlet 604, and through open cavity outlet 602. Air pump 610 may be disposed before open cavity 616 in the flow of air through the interior arrangement or air pump 610 may be disposed after open cavity 616.

Bio-fluorescing light 620 may be configured to cast ultraviolet (UV) light into open cavity 616 such that bio-aerosol particles are illuminated by bio-fluorescing light 620. In some embodiments, bio-fluorescing light 620 may comprise a UV-LED configured to display ultraviolet light. In some embodiments, bio-fluorescing light 620 may comprise a UV laser. In some embodiments, bio-fluorescing light 620 comprises a fluorescent bulb with a black light filter such that the fluorescent bulb produces UV light. In some embodiments, the UV light produced by bio-fluorescing light 620 is UV-A, UV-B, UV-C, VUV, or any combination thereof. Excess light produced by bio-fluorescing light 620 may be collected by light-reducing beam dump 612. In some embodiments, light-reducing beam dump 612 may be coated with a low-reflection, high energy absorbent material such that light is absorbed by the material rather than reflected into open cavity 616.

Bio-fluorescence detection sensor 618 is configured to detect the illumination of bio-aerosol particles by bio-fluorescing light 620 as they pass through open cavity 616. In some embodiments, bio-fluorescence detection sensor 618 comprises a light-detecting device such as a camera sensor. Further, the camera sensor may capture still photos of the bio-aerosol directed through the bio-aerosol detection unit and deliver the still photos to the computer processor and supporting electronics for analysis. The computer processor may then determine a bio-aerosol threat level based upon the results of the analysis and deliver the threat level to the user interface. Additionally, the bio-aerosol threat level may be displayed on display screen 104. In some embodiments, the camera sensor captures video recordings of the bio-aerosol particles directed through the bio-aerosol detection unit. The video may then be delivered to the processor for analysis for bio-aerosols particles. In some embodiments, bio-fluorescence detection sensor 618 comprises an avalanche photodiode configured to detect UV fluorescence.

In some embodiments, the computer processor present on electronics board 606 and 614 may calculate a background bio-aerosol level based on an observation period wherein bio-aerosol detection apparatus 100 operates to detect the level of bio-aerosols in the atmosphere for the observation period such that a reference ambient bio-aerosol level may be calculated and used during the calculation of threat levels. In some embodiments, the threat level is computed by comparing the current number of bio-aerosol particles to the background bio-aerosol level. In some embodiments, the threat level is calculated by comparing the rate of increase in bio-aerosol particle count as compared to the background bio-aerosol level. In some embodiments, the threat level is high when the rate of increase in bio-aerosol particle count exceeds a predetermined threshold. In some embodiments, the threat level is low when the rate of increase in bio-aerosol particle count falls below a predetermined threshold. In some embodiments, the predetermined threshold is set by a user when switching on the device. In some embodiments, the predetermined threshold is set when the device is manufactured. In some embodiments, the predetermined threshold is set when bio-aerosol detection apparatus 100 is calibrated. Further, embodiments are contemplated in which an initial default predetermined threshold is included in the manufactured device, but the user is able to selectively update the predetermined threshold. In some embodiments, the computer processor present on electronics boards 606 and 614 records the current level of bio-aerosol only and does not compare the current level to a background level. Instead, the computer processor present on electronics board 606 and 614 compares the recorded level of the bio-aerosol particles and compares the recorded level to a predetermined value. The predetermined value may be a standard safety level. In some embodiments, the predetermined value is set upon activation of the device. In some embodiments, the predetermined value is permanently stored on computer-readable media on electronics board 606 and 614 and may be updated when routine maintenance is done on bio-aerosol detection apparatus 100.

In some embodiments, the computer processor present on electronics boards 606 and 614 records bio-aerosol particle count data onto non-transitory computer-readable memory. The bio-aerosol particle count data may be recorded with a timestamp and a biological threat level reading. The bio-aerosol particle count data may be stored for background bio-aerosol particle level. Additionally, the bio-aerosol particle count data may be stored for analysis. The computer processor present on electronics boards 606 and 614 may also leverage stored bio-aerosol particle count data to predictively calculate threat levels based upon stored bio-aerosol particle count data. For instance, the computer processor present on electronics boards 606 and 614 may analyze short-term trends in bio-aerosol particle count data that indicate certain patterns in the bio-aerosol particle count data that reflect the approach of a high threat level. Further, the computer processor present on electronics boards 606 and 614 may record bio-aerosol detection data in a continuous stream of values (e.g., a line graph with continuous data representation), a discrete collection of values (e.g., a bar graph with discrete data points) or any combination thereof. The computer processor present on electronics boards 606 and 614 may also record the bio-aerosol detection data in a spreadsheet format for permanent records. In some embodiments, the bio-aerosol particle count data is associated with the number of bio-aerosol particles detected by bio-fluorescence detection sensor 618.

In some embodiments, bio-aerosol detection apparatus 100 further comprises a keypad for inputting information into bio-aerosol detection apparatus 100. In some embodiments, the keypad is communicatively connected to the computer processor present on electronics boards 606 and 614. In some embodiments, the keypad is disposed on the exterior of the device in the form of physical buttons. In some embodiments, the keypad is integrated into computer program code that, when executed by the computer processor present on electronics boards 606 and 614, causes the computer processor present on electronics boards 606 and 614 to display a digital keypad on display screen 104 such that the user may interact with the digital keypad to input information into bio-aerosol detection apparatus 100.

In some embodiments, the bio-aerosol detection apparatus 100 comprises a communications module 622. For example, a communications module 622 such as a wireless transceiver may be disposed on the electronics boards 606, as shown. Alternatively, or additionally, other forms of communication devices may be included. For example, a wireless antenna may be disposed on an external housing of the bio-aerosol detection apparatus 100.

In some embodiments, the communication system, such as the communications module 622, the wireless antenna, or any other communication device described herein, of the bio-aerosol detection apparatus 100 is configured to provide wireless communication over a wireless network. For example, the communications module 622 may be configured to transmit a signal indicative of a real-time threat level or air parameter over the wireless network to one or more remote devices. Accordingly, the remote devices may be used to monitor the bio-aerosol detection apparatus 100 from a remote location. Further, embodiments are contemplated in which the communications module 622 is configured to receive signals from a remote device such that a signal comprising operating instructions is received from the remote device.

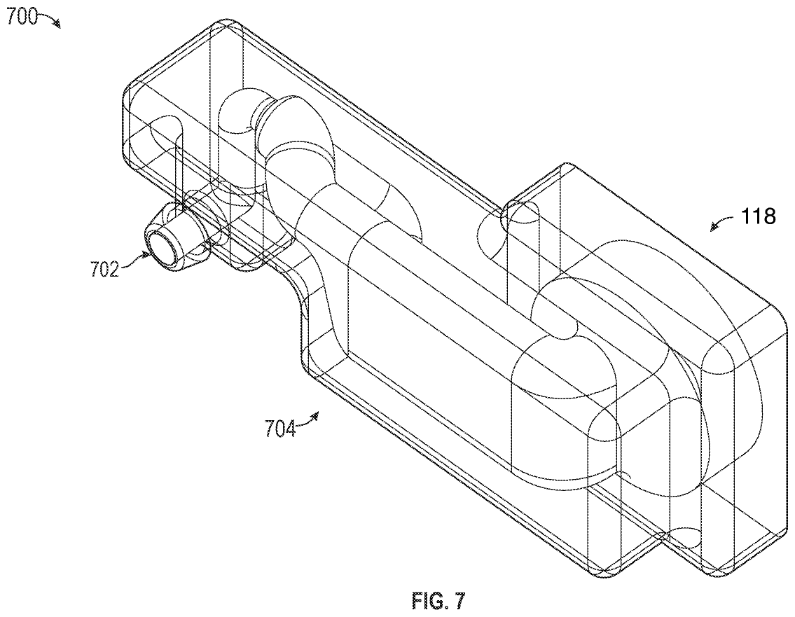

Turning now to FIG. 7, a view of interior inlet 608 is shown. Interior inlet 608 may comprise interior volume 704 configured to increase the pressure of air flowing through interior inlet adapter 702. In some embodiments, interior inlet adapter 702 is configured to attach to open cavity inlet 604 such that air flowing through interior inlet 608 flows through open cavity inlet 604. Interior inlet 608 further comprises inlet port 118. Furthermore, interior inlet 608 is disposed within outer housing 116 such that only inlet port 118 is visible from the exterior of outer housing 116. Inlet port 118 may be configured to attach to a hose such that the hose provides airflow to bio-aerosol detection apparatus 100. The hose may be configured to have an inlet tube connected to the end of the hose such that the inlet tube can be wielded by the user for close inspection of specific materials.

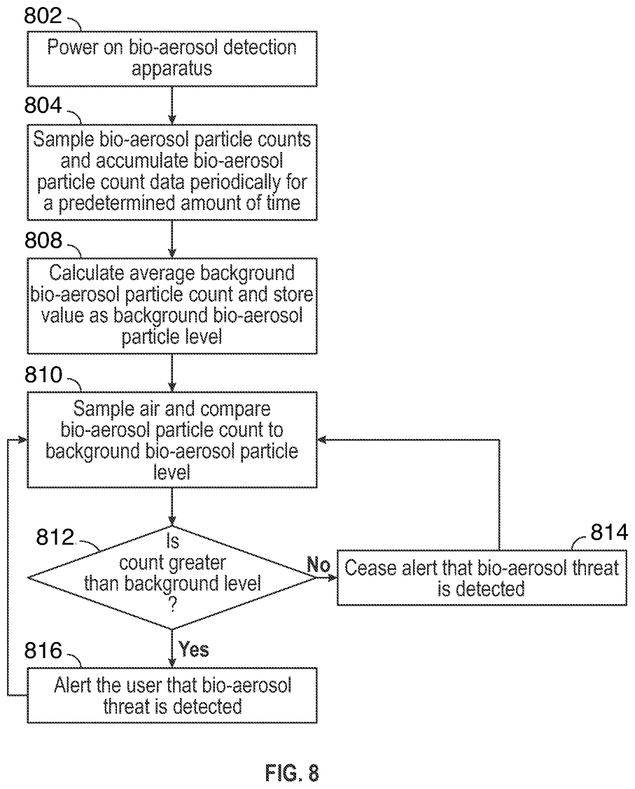

Turning now to FIG. 8 an exemplary method of operation for bio-aerosol detection apparatus 100 is depicted. At step 802, bio-aerosol detection apparatus 100 is powered on. Following step 802, step 804 begins a background bio-aerosol level calculation process by sampling bio-aerosol particle counts and accumulating bio-aerosol count data periodically for a predetermined amount of time. In some embodiments, the predetermined amount of time is entered by the user on the device. In other embodiments, the predetermined amount of time is set when bio-aerosol detection apparatus 100 is manufactured.

Following step 804, step 808 calculates the average background bio-aerosol particle count and stores the result as a background bio-aerosol particle level. Step 810 then moves to the general operation of the device. At step 810, bio-aerosol detection apparatus 100 samples air by drawing air through interior inlet 608. Bio-aerosol detection apparatus 100 then uses the bio-fluorescence detection sensor 618 and bio-fluorescing light 620 to calculate the current bio-aerosol particle count and compare the current bio-aerosol particle count to the previously calculated background bio-aerosol particle level. At test 812, if the current bio-aerosol particle count is greater than that of the previously calculated background level then the system proceeds to step 816 where bio-aerosol detection apparatus 100 activates one or more warning devices such as status LED 112, display screen 104, a speaker, and a vibration motor. The system then returns to step 810 where the process is conducted again. If the current bio-aerosol particle count is not greater than the background level, then bio-aerosol detection apparatus 100 proceeds to step 814 where bio-aerosol detection apparatus 100 ceases all alerts and resumes normal operation without alerting the user of a bio-aerosol threat. The system may cycle through steps 810-816 until the system is shut off or runs out of battery.

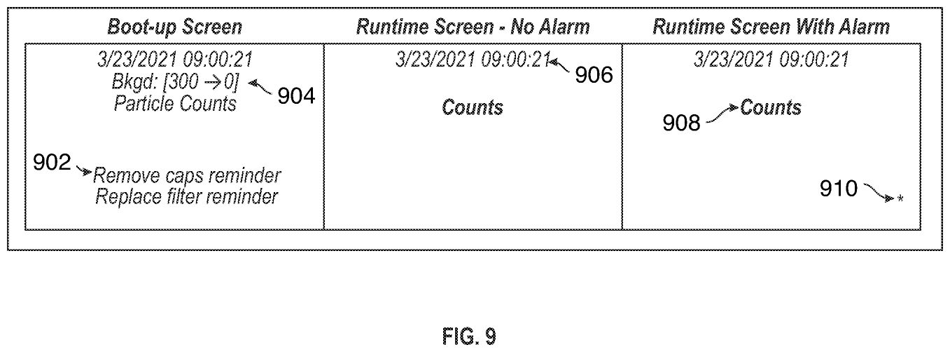

Turning now to FIG. 9, an exemplary embodiment of the graphical user interface displayed on display screen 104 is shown. The graphical user interface may include several pieces of information not displayed in this figure and the layout displayed is not intended to be limiting. When appropriate, the graphical user interface may display a reminder for the user to remove inlet and outlet caps. Additionally, the graphical user interface may include a reminder for the user to replace the filter present in bio-aerosol detection apparatus 100 when necessary. Both the remove caps reminder and filter replacement reminder are shown in reminder text 902. The graphical user interface may display information regarding the calculation of the background bio-aerosol particle level. This is displayed in background information 904. The graphical user interface may include date and time display 906. This information is provided by the computer processor and supporting electronics. The graphical user interface may further include bio-aerosol particle count display 908. The graphical user interface may further include bio-aerosol threat indicator 910. Bio-aerosol threat indicator 910 may be displayed when a threat is detected. In some embodiments, bio-aerosol threat indicator 910 may flash on display screen 104 when a threat is detected. In some embodiments, bio-aerosol threat indicator 910 may remain present on screen until the threat is no longer detected. Alternatively, or additionally, in some embodiments, the bio-aerosol threat indicator 910 may persist for a predetermined period of time such as 1 minute, 5 minutes, 10 minutes, or another suitable period of time.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed, and substitutions made herein without departing from the scope of the invention as recited in the claims.

Having thus described various embodiments of the invention, what is claimed as new and desired to be protected includes the following:

1. A wearable bio-aerosol detection apparatus comprising:
an outer housing;
an inlet disposed within the outer housing;
an outlet configured to exhaust air from within the wearable bio-aerosol detection apparatus;
an air pump configured to draw the air through the inlet disposed within the outer housing;
a bio-aerosol detection unit disposed within the outer housing comprising:
an open cavity configured to receive the air from the inlet disposed within the outer housing, and to exhaust the air to the outlet;
a bio-fluorescing light configured to illuminate the open cavity;
a single bio-fluorescence detection sensor configured to observe the open cavity; and
a light reducing beam dump configured to receive excess light from the bio-fluorescing light illuminating the open cavity.

2. The wearable bio-aerosol detection apparatus of claim 1, wherein the bio-fluorescing light comprises a UV-LED that produces ultraviolet light to fluoresce bio-aerosol particles.

3. The wearable bio-aerosol detection apparatus of claim 1, further comprising:
a computer processor and supporting electronics configured to receive data from the bio-aerosol detection unit and further configured to calculate a number of bio-aerosol particles present in the open cavity, the computer processor further configured to detect when the number of bio-aerosol particles exceeds a predetermined threshold.

4. The wearable bio-aerosol detection apparatus of claim 3, further comprising:
a display screen configured to receive bio-aerosol particle count data from the computer processor and display particle count data associated with the number of bio-aerosol particles.

5. The wearable bio-aerosol detection apparatus of claim 4, wherein the display screen is further configured to display an alert when the number of bio-aerosol particles exceeds the predetermined threshold.

6. The wearable bio-aerosol detection apparatus of claim 5, wherein the predetermined threshold is selected by a user of the wearable bio-aerosol detection apparatus.

7. The wearable bio-aerosol detection apparatus of claim 1, further comprising a MOLLE bracket attachment point and MOLLE bracket alignment tabs configured to receive a MOLLE bracket.

8. The wearable bio-aerosol detection apparatus of claim 1, wherein the light reducing beam dump is composed of low-reflectivity, high energy absorbent material.

9. A wearable bio-aerosol detection apparatus comprising:
an outer housing;
an inlet disposed within the outer housing;
an air pump configured to draw air through the inlet disposed within the outer housing;
an outlet configured to exhaust the air from within the wearable bio-aerosol detection apparatus;
a bio-aerosol detection unit disposed within the outer housing comprising:
an open cavity configured to receive the air from the inlet disposed within the outer housing and to exhaust the air through the outlet;
a bio-fluorescing light configured to illuminate the open cavity;
a single bio-fluorescence detection sensor configured to observe the open cavity; and
a light reducing beam dump configured to receive excess light from the bio-fluorescing light illuminating the open cavity;
a user interface comprising:
a multi-select switch;
a keypad for inputting input information; and
a display screen.

10. The wearable bio-aerosol detection apparatus of claim 9, further comprising a status LED configured to display warning alerts in an infrared and visible light spectrum.

11. The wearable bio-aerosol detection apparatus of claim 9, further comprising:
a computer processor configured to:
receive data from the bio-aerosol detection unit;
calculate a number of bio-aerosol particles present in the open cavity; and
alert a user via the display screen when the number of bio-aerosol particles passes a predetermined threshold.

12. The wearable bio-aerosol detection apparatus of claim 9, further comprising a MOLLE bracket attachment point and MOLLE bracket alignment tabs to be used in conjunction with a MOLLE bracket.

13. A system for bio-aerosol detection, the system comprising:
an outer housing;
a user interface comprising at least two of:
a multi-select switch;
a display screen;
and a status LED;
an interior inlet comprising:
an open cavity within the outer housing; and
an inlet port through the outer housing;
a bio-aerosol detection unit comprising:
a bio-fluorescing light;
a bio-fluorescence detection sensor; and
a light reducing beam dump;
an exterior outlet comprising:
an outlet port; and
an outlet port seal;
a filter for collecting samples of bio-aerosols detected by the bio-aerosol detection unit; and
at least one non-transitory computer-readable memory containing computer program code that, when executed by a processor, cause the processor to:
receive bio-aerosol detection information from the bio-aerosol detection unit;
analyze the bio-aerosol detection information;
compute a threat level based upon the bio-aerosol detection information; and
display the threat level via the user interface.

14. The system of claim 13, further comprising a MOLLE bracket attachment point wherein the MOLLE bracket attachment point connects to a MOLLE bracket configured to interface with a MOLLE system.

15. The system of claim 14, further comprising at least one MOLLE bracket alignment tab for aligning the MOLLE bracket with the MOLLE bracket attachment point.

16. The system of claim 13, further comprising an internal buzzer for audibly alerting a user to a presence of a biological threat.

17. The system of claim 13, further comprising an air pump for driving a flow of air through the bio-fluorescence detection sensor.

18. The system of claim 13, wherein the outlet port seal comprises a thumb screw and a gasket disposed around the thumb screw, the thumb screw configured to seal the outlet port from water ingress.

19. The system of claim 13, further comprising a waterproof SD card compartment and an SD card configured to receive the bio-aerosol detection information from the processor such that the bio-aerosol detection information is stored on the SD card.

20. The system of claim 13, wherein the bio-fluorescence detection sensor comprises a single photomultiplier tube configured to detect fluorescence of the bio-aerosols.
